(19) United States
(12) Patent Application Publication
(10) Pub. No.: US 2025/0156943 A1
(43) Pub. Date: May 15, 2025

(54) SYSTEM AND METHOD FOR RULE-BASED LOAN VALIDATION

(71) Applicant: Wells Fargo Bank, N.A., San Francisco, CA (US)

(72) Inventors: Greg Daniel Cooper, Charlotte, NC (US); Vinayak Balu Salunke, Charlotte, NC (US); Avishek Sarkar, Bangalore (IN); Rini Sarkar, Bengaluru (IN); Yi Wang, San Ramon, CA (US)

(21) Appl. No.: 18/506,023

(22) Filed: Nov. 9, 2023

(51) Int. Cl. G06Q 40/03; G06F 16/2455; G06F 16/25; G06Q 40/12

(52) U.S. Cl. CPC G06Q 40/03; G06F 16/24564; G06F 16/254; G06Q 40/12

(57) ABSTRACT

Aspects of the present disclosure include methods for retrieving a loan data stored in a first data store containing commercial and industrial (C&I) loan data, commercial real estate (CRE) loan data, off-balance sheet (OBS) loan data, commitment to issue a commitment (CTC) loan data, or a combination thereof. The methods additionally include retrieving, from a second data store, a set of configurable business rules, and selecting, via a loan validation tool (LVT) system executable via one or more processors, one or more configurable business rules from the set of configurable business rules based on characteristics of the retrieved loan data. The methods further include applying, via the LVT system, the selected configurable business rules to the loan data to validate the loan data, and generating a loan validation result, wherein the configurable business rules are updatable in the second data store without interruption to operations of the LVT system.

### TECHNICAL FIELD

The present disclosure generally relates to automated loan validation, and more specifically to dynamic rule-based loan validation.

### BACKGROUND

Clients engage in a variety of transactions, for example, by using financial institutions such as banks. For example, transactions can include requesting loans, such as commercial real estate loans. The banks process the transactions and can derive certain validation results, including regulatory reports.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a block diagram illustrating online distributed system that includes a Loan Validation Tool (LVT) system, in accordance with certain examples.

FIG. 2 is a block diagram illustrating an example data flow for the LVT system of FIG. 1, in accordance with certain examples.

FIG. 3 illustrates a flowchart of an example process suitable for executing business rules against certain input to validate loan data, in accordance with certain examples.

FIG. 4 is an example screenshot of a configurable rules editor, in accordance with certain examples.

FIG. 5 is a block diagram depicting a machine suitable for executing instructions via one or more processors, in accordance with certain examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automatically analyzing large amounts of financial data to provide for commercial client-focuses loan validation and the creation of reports for timely regulatory reporting. In certain examples, a Loan Validator Tool (LVT) system is provided. In one example, the LVT system is an online distributed system used for processing data for regulatory reports and Off-Balance Sheet (OBS) use. OBS refers to certain assets and/or liabilities that are not recorded in a company's balance sheet. For example, when a loan is securitized and sold off as an investment, the secured debt is likely kept of the company's books. The LVT system also processes and/or creates commercial and industrial (C&I) as well as commercial real estate (CRE) portfolio data and/or processes, including commitment to issue a commitment (CTC) data and/or processes. CTC refers to the issuance of commitment letters, for example, to extend credit, such as when purchasing a company, a building, and so on.

In some embodiments, the LVT system automates an approval workflow for daily regulatory reporting for CTC, performs lifecycle management in a CTC transaction, C&I and CRE data validation and integration, as well as centralized federal edit checks for CRE and C&I loans. The LVT system further provides an automated report subscription process that provides a variety of reports, including reports mandated by regulatory authorities. The LVT system provides enhanced security, data management, accessibility, scalability, and integration, via an online practical application that enables the use of the LVT system by various entities.

In certain examples, certain configurable rules (e.g., business rules) are provided. For example, OBS configurable rules are created and used to automatically validate certain OBS data and/or processes. The configurable rules are stored, or example in a relational database, as templates that can be further customized. In use, the LVT system retrieves the configurable rules and applies the configurable rules to process large volumes (e.g., greater than 100,000 rows) of OBS data (e.g., data for an entire time range such as monthly data for all OBS customers). In some examples, some of the configurable rules may be paused or worked on in the background while the remainder of the configurable rules can be executed in the background, resulting in more efficient customization and data processing.

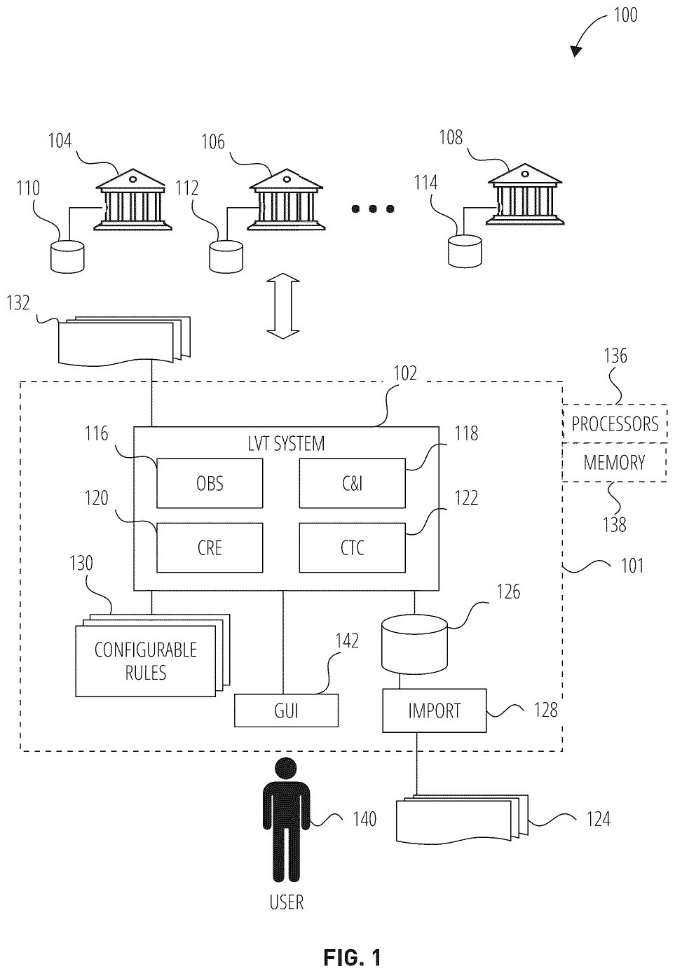

Turning now to FIG. 1, the figure is a block diagram of a system 100 that includes an online distributed system 101 that includes an LVT system 102, according to certain examples. In the depicted embodiment, the LVT system 102 is communicatively coupled to certain reporting systems of regulatory institutions 104, 106. The regulatory institutions 104, 106 can include financial regulatory institutions such as the Federal Deposit Insurance Corporation (FDIC), the Securities and Exchange Commission (SEC), the Federal Reserve Bank (FRB), Office of the Comptroller of the Currency (OCC), state regulatory agencies, banking regulatory agencies, and so on. The LVT system 102 is also communicatively coupled to other reporting systems of other entities, such as an entity 108. The entity 108 can be a loan customer, a loan broker, an auditor entity, and so on. Each financial institution and/or entity includes data stores 110, 112, 114 that are used to process and store certain regulatory records, such as FR Y-14Q Schedule H (e.g., H.1 and H.2) records for the FRB, as well as FDIC compliance records, SEC reporting records, loan origination records, loan processing records, loan validation reports, and so on.

The LVT system 102 includes an Off-Balance Sheet (OBS) system 116, a commercial and Industrial (C&I) system 118, a commercial real estate (CRE) system 120, and a commitment to issue a commitment (CTC) system 122. The OBS system 116 provides for validation and reporting of certain assets and/or liabilities that are not recorded in a company's balance sheet. In some embodiments, Off-Balance Sheet lending commitments are “unused commitments” for loans, leases, syndications, participations, purchases of assets and are reported in the following FRB Regulatory Reports: FR Y-9C, FR Y-14Q/M, FR Y-1, FR 2052a FFIEC 031, FFIEC 101, FFIEC 009, and so on. The OBS system 116 receives as input various records 124 that include OBS data, such as data that indicates if there are OBS implications of a product being supported by the LVT system 102, such as a credit product within a business-to-business type loan. In some examples, an OBS implication can include a financial services provider (e.g., bank) of the credit product having a contractual obligation to extend credit (e.g., additional credit or “upsize”) or purchase assets based on certain financial conditions. The OBS data can include an obligor name, account identification, commitment information (e.g., amount of upsize, scheduled start of upsize, upsize end date, borrowing base commitment amount, OBS balance type (e.g., seasonal, upsize, obligatory), and so on).

In the depicted example, the records 124 are recurring records. That is, new records are created monthly, daily, hourly and stored, for example, as files or in any other type of data store. The records 124 are uploaded into a data store 126 via an import system 128. In some examples, the data store 126 is a relational database storing records in searchable tables. The LVT system will then use a set of configurable rules 130 to validate data, including OBS data, as further described below. The data validation then results in certain reports 132, such as the aforementioned FRB regulatory reports, to be provided to the various regulatory and other entities 104, 106, 108.

The C & I system 118 also uses records 124 imported into the data store 126 as input, and derives certain validations related to commercial and industrial financial products, such as loan products, investment products, and the like. For example, the C & I system 118 includes processes suitable for automatically validating data and creating a FR Y-14Q, Schedule H.1 (Corporate) report for the FRB. For example, collateral market value reporting is based on firms reporting the market value of collateral as of the reporting date, and to report “NA” if the value of the collateral has not been updated since reported on the previous Schedule H.1 submission. The value of collateral can be recorded, such as receivables and inventory comprising a borrowing base for asset-based lending. The legal entity providing the primary source of repayment or, if different, the legal entity used by underwriting as the primary source of repayment identified is also processed and reported. More generally, Schedule H.1 includes various “items” available through the FRB, for processing and reporting via reports 132.

The CRE system 120 uses the records 124 imported into the data store 126 as input, and derives certain validations related to commercial real estate financial products, such as loan products, investment products, and the like, targeting real estate. For example, the loan products include CRE loans and leases that are held for investment (HFI) and held for sale (HFS) as of the report date (e.g., quarter end). CRE data in the records 124 include HFI and HFS loans that the holding company has elected to report at fair value under the fair value option. Further, CRE loans and leases can be defined as loan commitments or credit facilities to an obligor as set forth in credit agreements. The CRE system 120 validates CRE data to automatically create a report, such as a FR Y-14Q, Schedule H.2 report, for the FRB via reports 132.

The CTC system 122 uses the records 124 imported into the data store 126 as input and derives certain validations related to commitment to issue a commitment (CTC) data and/or processes. As mentioned earlier, CTC refers to the issuance of commitment letters, for example, to extend credit, such as when purchasing a company, a building, and so on. CTC records can include commitment classification, commitment amount, proposed facility high risk borrower code (e.g., yes or no), proposed facility leveraged code (e.g., is leveraged or is not leveraged), issuance limit, and so on. The CTC system 122 then validates the input records and derives reports, which may also include sections of the FR Y-14Q, Schedule H.1 and/or H.2 reports.

The reports 132 can then be submitted to the reporting systems of the entities 104, 106, 108. For example, an online submission system, such as FRB's report center, may be used to upload the reports 132. The uploading can happen at scheduled intervals (e.g., daily, weekly, monthly, yearly) to meet certain regulatory and/or contractual schedules. It is to be noted that the input records, e.g., records 124 used to create the various reports 132 are also, in some examples, created by the LVT system 102 itself. That is, the LVT system 102 can be used as an authoring tool to create new OBS, C & I, CRE, and/or CTC records for use in validation and reporting activities.

The configurable rules 130, in some embodiments, are stored in a data store such as the data store 126 or in another data store accessible to the LVT system 102. In some examples, the configurable rules 130 include business rules data are executable via the LVT system 102 to validate OBS, C & I, CRE, and/or CTC processes and/or data. For example, rules include rules that define numeric ranges that certain fields should take (e.g., over $100,000), textual ranges to use (e.g., “Yes”, “No”), computations that should take place (e.g., Boolean logic computation and/or mathematical computation), financial guidelines, insurance guidelines, risk mitigation guidelines, reporting guidelines and so forth. For example, the business rules can look at specific criteria like income, credit history, and outstanding debts to determine which loans to approve.

Likewise, the business rules can be used to define OBS. C & I, CRE, and/or CTC processes to achieve stress testing of a financial institution and/or perform a capital assessment of a financial institution. For example, detailed data on bank holding companies' (BHCs), savings and loan holding companies' (SLHCs), and intermediate holding companies' (IHCs) quantitative projections of balance sheet assets and liabilities, income, losses, and capital across a range of macroeconomic scenarios and qualitative information are then used, via the configurable rules 130, to develop internal projections of capital across various financial scenarios. The configurable rules 130 are used to assess the capital adequacy of large firms using forward-looking projections of revenue and losses, to support supervisory stress test models, and continuous monitoring efforts as well as to inform operational decision-making.

In certain examples, the business rules are updatable in the rules database with minimal or no interruption to operations of the LVT system 102. For example, the LVT system 102 can retrieve the business rules from the data store 126 into working memory (e.g., random access memory) and “lock” the working memory to use the business rules while one or more uses can edit the business rules via the data store 126, e.g., via structured query language (SQL). Once the user(s) have completed their editing, a SQL trigger (e.g., insert, update, and/or delete trigger) can notify the LVT system 102 that editing has occurred and the LVT system 102 can then reload the edited rule(s) into working memory.

The LVT system 102 is shown as hosted by a distributed network 101 of multiple processors 136 that utilize memory 138 (e.g., online shared memory) to execute the LVT system 102. That is, the LVT system 102 is an online distributed system that can use the processors 136 and memory 138 for load balancing, scalability, improved data management, and integration. Users 140 can interface with the LVT system 102 via a graphical user interface (GUI) 142. The GUI 142 can include mobile application GUIs, web GUIs, desktop application GUIs, and so on, suitable for operationally interfacing with the LVT system 102. In certain examples, the LVT system 102 can be implemented as computer software, such as using cloud and/or microservice based systems, e.g., via ReactJS, Redux, Java Spring Boot, Oath2 JWT authorization and Cloud compatible design.

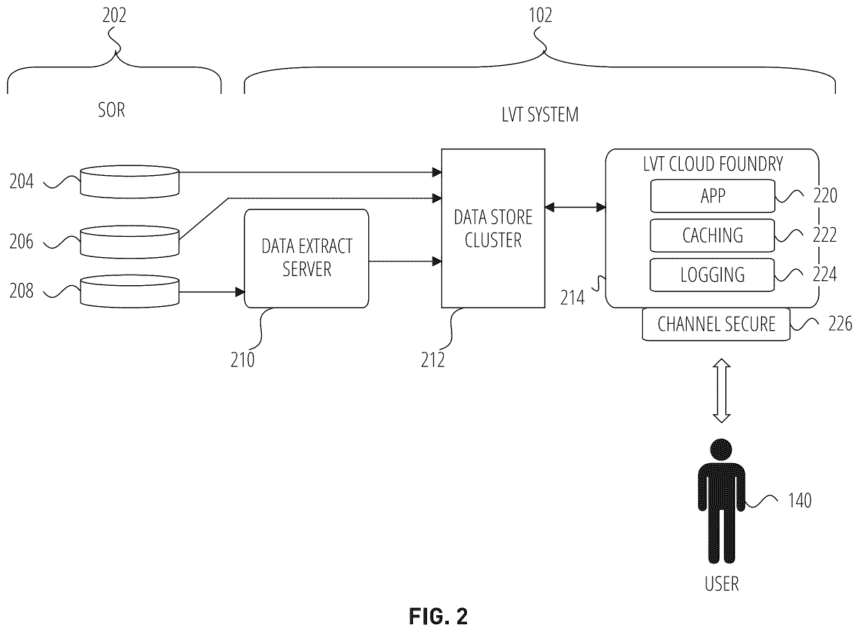

FIG. 2 is a block diagram illustrating an example data flow for the LVT system 102, according to certain examples. In the depicted example, a system of record (SOR) 202 includes various data stores 204, 206, 208. The SOR 202 is a high priority information storage and management system that serves as the authoritative data source, for example, to mission critical information. That is, the SOR 202 is used as the definitive source of data when there are data conflicts, e.g., when data may be found in multiple data stores.

In certain examples, records related to reference data and contact master data are stored in data store 204, records (e.g., account records) related to a financial institution (e.g., bank) are stored in data store 206, and records related to human resources (e.g., contact information, email) involved in a loan validation process are stored in data store 208. The records stored in the SORs are equivalent to the records 124. In operations, a data extract server 210 performs extract, transform, and load (ETL) operations on the data store 208 to move certain data into a data store cluster 212. The data store cluster 212 includes multiple data stores (e.g., relational databases) that are synchronized and load balanced to distribute operational workloads and data allocation. For example, the data store cluster 212 can use a number of data requests to load balance data requests based on a number of data requests being initiated by the LVT system 102. In the depicted embodiment, the data store cluster 212 is shown as communicatively coupled to the data stores 204, 206 to move or to copy certain data (e.g., reference data, financial data) into the data store cluster 212. The data cluster 212 and/or the data extract server 210 use various techniques, such as Java Database Connectivity (JDBC), DB Link, SQL code, batch processing of text, and so on, to extract and/or to process data from the data stores 204, 206, 208.

The data cluster 212 is communicatively coupled to an LVT cloud foundry 214. The LVT cloud foundry 214 is, in some examples, a multi-cloud application platform as a service (PaaS) that provides for a container-based architecture (e.g., using Kubernets) suitable for delivering a marketplace of various services. Services include ETL services, application services, login services, business rule execution services, caching services, logging services, and so on. In the depicted embodiment, an application 220 is provided. The application 220 is a web-deliverable application that can be executed via a mobile device, a desktop computer, a tablet, and so on. In some examples, the application 220 includes a ReactJS client providing native and/or web user interfaces, one or more web services components providing certain data access and processing of data store cluster 212 data, and object relational mapping (ORM) components that map objects (e.g., classes) to relational (e.g., table-based) data. Accordingly, object, such as Java classes, are more efficiently stored in relational databases, such as the data stores included in the data cluster 212.

Caching is provided via a caching system 222, while logging is provided via a logging system 224. In use, certain programming objects, data, and the like, are stored in the caching system 222 for more efficient access. The logging system 224 is used to log various events, data transfers, user actions, and the like. A channel secure component 226 is also shown, providing a more secure access to the LVT cloud foundry 214. For example, enhanced communication security is provided via Hypertext Transfer Protocol Secure (HTTPS) protocol, via secure tokens, via challenge response systems, and/or via multifactor authentication. In operations, the user 140 operatively interfaces with the LVT cloud foundry 214 via the channel 226 to more securely access the app 220, for example.

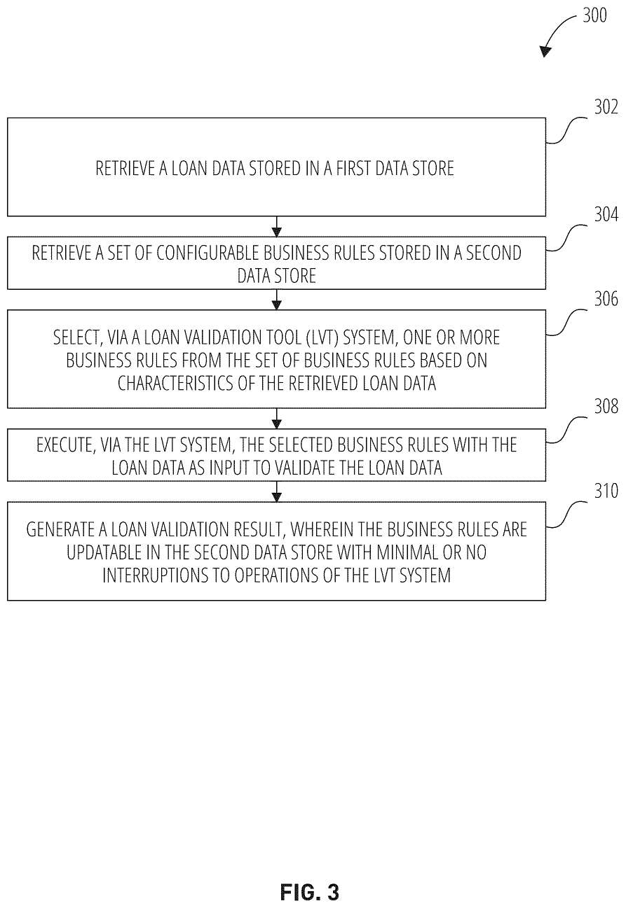

FIG. 3 is a flowchart of an example process 300 suitable for executing business rules against certain input to validate loan data, according to some examples. At block 302, the process 300 retrieves a loan data stored in a first data store containing commercial and industrial (C & I) loan data, commercial real estate (CRE) loan data, off-balance sheet (OBS) loan data, commitment to issue a commitment (CTC) loan data, or a combination thereof. In some examples, the first data store is the data store 126. The C & I data includes data useful in creating a FR Y-14Q, Schedule H.1 (Corporate) report for the Federal Reserve Bank (FRB). For example, market value of collateral can be stored a C & I loan data, such as receivables and inventory comprising a borrowing base for asset-based lending. The legal entity providing the primary source of repayment or, if different, the legal entity used by underwriting as the primary source of repayment identified can also be stored as C & I data. The CRE loan data includes data useful in creating a FR Y-14Q, Schedule H.2 report for the FRB. CRE loan data includes commercial real estate financial products, such as loan products, investment products, and the like, targeting real estate. For example, the loan product data includes CRE loans and leases that are held for investment (HFI) and held for sale (HFS) as of the report date (e.g., quarter end). CRE loan data include HFI and HFS loans that the holding company has elected to report at fair value under the fair value option. Further, CRE loans and leases can be included in the CRE loan data, such as loan commitments or credit facilities to an obligor as set forth in credit agreements.

The OBS loan data includes lending commitments for loans, leases, syndications, participations, purchases of assets and data to be reported in the following FRB Regulatory Reports: FR Y-9C, FR Y-14Q/M, FR Y-1, FR 2052a FFIEC 031, FFIEC 101, FFIEC 009, and so on. The OBS loan data includes data that indicates if there are OBS implications of a product being supported by the LVT system 102, such as a credit product within a business-to-business type loan. In some examples, an OBS implication can include a financial services provider (e.g., bank) of the credit product having a contractual obligation to extend credit (e.g., additional credit or “upsize”) or purchase assets based on certain financial conditions. The OBS loan data also includes an obligor name, account identification, commitment information (e.g., amount of upsize, scheduled start of upsize, upsize end date, borrowing base commitment amount, OBS balance type (e.g., seasonal, upsize, obligatory), and so on). The CTC loan data includes data related to the issuance of commitment letters, for example, to extend credit, such as when purchasing a company, a building, and so on. In some examples, CTC loan data also includes commitment classification, commitment amount, proposed facility high risk borrower code (e.g., yes or no), proposed facility leveraged code (e.g., is leveraged or is not leveraged), issuance limit, and so on.

At block 304, the process 300 retrieves, from a second data store, a set of configurable business rules (e.g., configurable rules 130). As mentioned earlier, the business rules include rules that define numeric ranges that certain fields should take (e.g., over $100,000), textual ranges to use (e.g., “Yes”, “No”), computations that should take place (e.g., Boolean logic computations and/or mathematical computations), financial guidelines, insurance guidelines, risk mitigation guidelines, reporting guidelines and so forth. For example, the business rules can look at specific criteria like income, credit history, and outstanding debts to determine which loans to approve. Likewise, the business rules can be used to define OBS, C & I, CRE, and/or CTC processes to achieve stress testing of a financial institution and/or perform a capital assessment of a financial institution. For example, detailed data on bank holding companies' (BHCs), savings and loan holding companies' (SLHCs), and intermediate holding companies' (IHCs) quantitative projections of balance sheet assets and liabilities, income, losses, and capital across a range of macroeconomic scenarios and qualitative information are then used, via the business rules, to develop internal projections of capital across various financial scenarios. The business rules are also used to assess the capital adequacy of large firms using forward-looking projections of revenue and losses, to support supervisory stress test models, and continuous monitoring efforts as well as to inform operational decision-making.

In block 306, process 300 selects, via the LVT system 102 executable via a distributed network of processors 136, one or more business rules from the set of business rules based on characteristics of the retrieved loan data. For example, loan data having C & I characteristics or tags will be used for C & I purposes, loan data having CRE characteristics or tags will be used for CRE purposes, loan data having OBS characteristics or tags will be used for OBS purposes, and loan data having CTC characteristics or tags will be used for CTC purposes. Similarly, characteristics of the retrieved loan data may include tags that tell the LVT system 102 that the loan data is to be used for reporting certain report types, such as FR Y-14Q, Schedule H.1, FR Y-14Q, Schedule H.2, FR Y-9C, FR Y-14Q/M, FR Y-1, FR 2052a FFIEC 031, FFIEC 101, FFIEC 009, and so on. In some examples, the data is analyzed to determine certain characteristics, including report type characteristics. For example, certain keywords such as “off the books”, “risk type”, “other assets”, and so on, can be used to determine report type characteristics by analyzing the number of keywords that occur in a given file.

At block 308, the process 300 executes, via the LVT system, the selected business rules to the loan data to validate the loan data. For example, the business rules include certain executable code (e.g., SQL, text parsers, data transforms, Boolean logic, and so on), that is applied to the loan data. The execution of the business rules then, at block 310, generates a loan validation result. The loan validation result can include a report that lists missing data for a report type, invalid data (e.g., values are out of a desired range, values are textual when they should be numeric, missing values, and so on), incorrect data (e.g., a total value doesn't add up based on subtotal values, values are of the incorrect type (e.g., should be in U.S. dollars and instead of Japanese yen), and so on). The loan validation result also includes metrics such as a validation metric that determines a validation percent for the loan data. In one example, the validation metric is a pass metric or a fail metric based on whether a data item passes or fails validation. The validation result is then a pass percentage based on the percentage of data items in the loan data that pass validation, and a fail percentage based on the percentage of data items that fail validation.

In some examples, the business rules are updatable with minimal or no interruption to operations of the LVT system 102. In some examples, the LVT system 102 will load the business rules into local memory (e.g., random access memory, shared memory, memory 138, and so on), and operate on the loan data retrieved. A user can then edit the business rules stored in the data store (e.g., data store 126), for example, using a lock (e.g., SQL lock, using a “lock” or “is active” flag, and so on). Minimal interruption, e.g., 5 minutes or less, can occur for locking, synching between data stores, and so on. Once the edit is complete, the rule can be unlocked and the LVT system 102 can retrieved edited rules to process the loan data. Likewise, loan data can be processed first with unlocked rules and as locked rules become unlocked, the newly unlocked rules are then executed against the loan data. In this manner, a more efficient rule-based processing of loan data is provided.

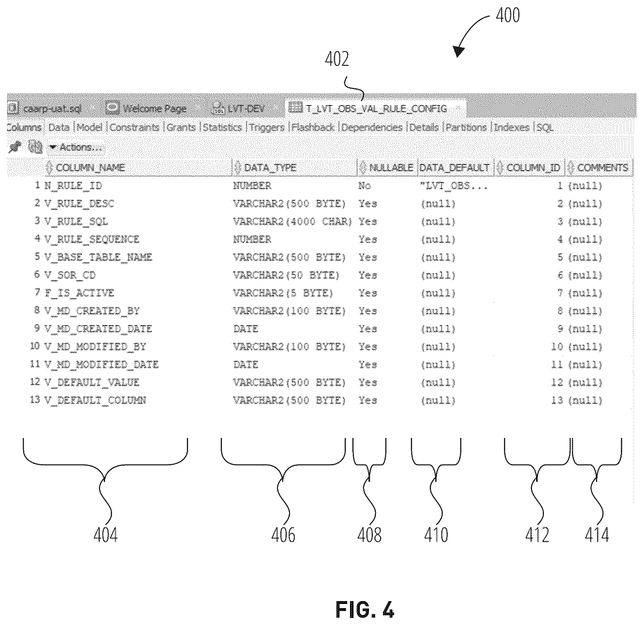

FIG. 4 is an example screenshot of a configurable rules editor 400, according to some examples. In the depicted example, the configurable rule editor 400 is a table-based editor showing a tab 402 having a table view of a configurable rule. More specifically, the table view shown includes columns 404-414. Column 404 is used for columns names of a table-based configurable rule, such as the configurable rules 130. The column 404 includes various values that define a rule. For example, a rule ID is used as a unique rule identifier, a rule description provides for textual description of the rule, a rule SQL is used to store programmatic SQL code, rule sequence is used to provide for a numeric sequence of rule execution, base table name is used to enter a relational database table name to store the rule, a rule “is active” flag is used to activate or deactivate the rule, a created by variable is used to store a creator of the rule, a created by date is used to store the date of rule creation, a modified by variable is used to store authorship of rule modifications, a modified date stores dates of modification, a default value stores defaults numbers, text, and so on, and a default column stores a column for storing default values. In an example, the LVT system is configured to load a configurable business rule into a memory when retrieving a set of configurable business rules from a data store only when the flag for that configurable business rule is set to active.

Column 406 is used to define a data type for the information stored in column 404. For example column 404 defines rule ID as having a number data type, rule description as having a 500 byte variable character data type, rule SQL as having a 4000 character data type, and so on. Column 408 defines whether or not the information stored in column 404 is nullable. For example, some information must be present, while other information is optional and can be set to null. Column 410 stores any default values for the information in column 404, while column 412 stores a column ID for the information in column 404. Comments for each information stored in column 404 can be stored in column 414. Accordingly, a rule, can be created, edited and modified. Indeed, in some examples, a new rule can be created while the LVT system 102 is executing other rules, and then activated (e.g., via the “is active” flag) to be used in subsequent LVT system 102 executions.

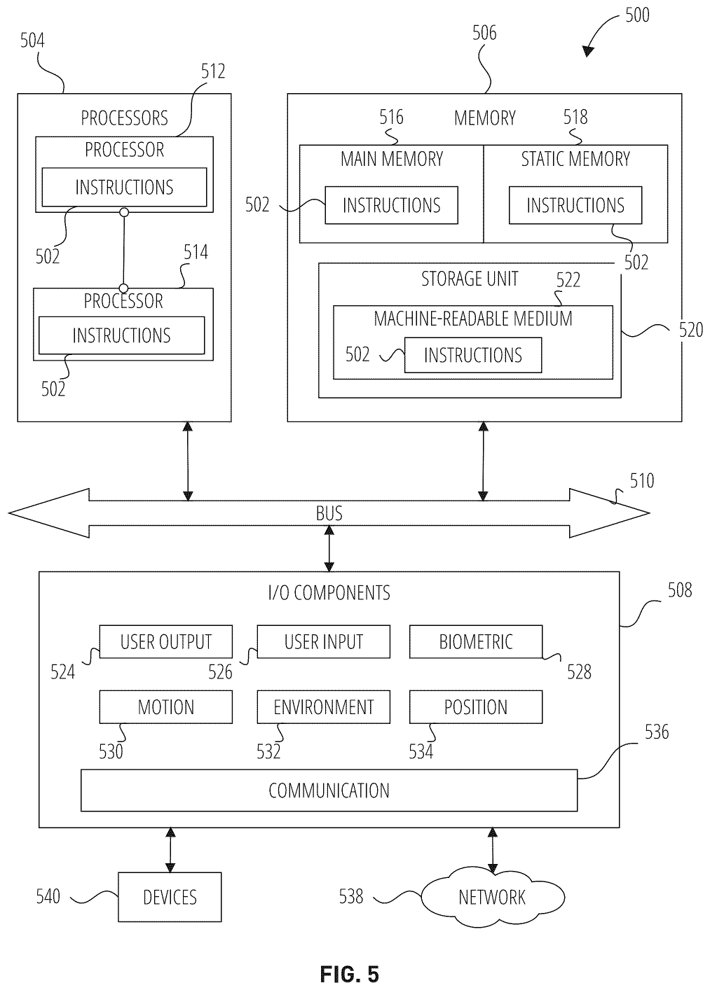

FIG. 5 is a diagrammatic representation of a machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the processes or methods described herein, such as the process 300. The instructions 502 transform the general, non-programmed machine 500 into a particular machine 500, e.g., the LVT system 102, programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 508, which may be configured to communicate with each other via a bus 510. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 512 and a processor 514 that execute the instructions 502. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 516, a static memory 518, and a storage unit 520, both accessible to the processors 504 via the bus 510. The main memory 516, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 may include biometric components 528, motion components 530, environmental components 532, or position components 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 534 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a universal serial bus (USB) port), internet-of-things (IoT) devices, and the like.

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

What is claimed is:

1. A system, comprising:
one or more processors;
a first data store storing loan data including commercial and industrial (C&I) loan data, commercial real estate (CRE) loan data, off-balance sheet (OBS) loan data, commitment to issue a commitment (CTC) loan data, or a combination thereof;
a set of configurable business rules stored in a second data store; and
a loan validator tool (LVT) system executable on the one or more processors and configured to:
retrieve the loan data from the first data store;
retrieve the set of configurable business rules from the second data store;
select one or more configurable business rules from the set of configurable business rules based on a characteristic of the retrieved loan data;
execute the selected one or more configurable business rules using the loan data as input to validate the loan data;
generate a loan validation result; and
update one or more configurable business rules in the set of configurable business rules via the second data store with minimal or no interruptions to operations of the LVT.

2. The system of claim 1, wherein each configurable business rule in the set of configurable business rules includes executable code.

3. The system of claim 2, wherein the executable code comprises a structured query language (SQL) code configured to use the loan data as input and to output a validation metric.

4. The system of claim 3, wherein the validation metric comprises a pass metric or fail metric.

5. The system of claim 4, wherein the validation result comprises a pass percentage of the loan data that includes the pass metric, a fail percentage of the loan data that includes the fail metric, or a combination thereof.

6. The system of claim 1, wherein the LVT system comprises an editor configured to edit the set of configurable business rules.

7. The system of claim 6, wherein the editor comprises a table view of a configurable business rule in the set of configurable business rules, the table view comprising columns that define the configurable business rule.

8. The system of claim 7, wherein the columns comprise a rule ID column uniquely identifying the configurable business rule, a SQL column for storing executable SQL code, and an “is active” column comprising a flag to denote if the configurable business rule is to be executed during the execution of the selected one or more configurable business rules or if the configurable business rule is to be not executed during the execution of the selected one or more configurable business rules.

9. The system of claim 8, wherein the set of configurable business rules are updatable in the second data store without interruption to operations of the LVT system based on the “is active” column, or with minimal interruption to operations of the LVT system based on the “is active” column.

10. The system of claim 9, wherein the LVT system is configured to load the configurable business rule into a memory when retrieving the set of configurable business rules from the second data store only when the flag is set to active.

11. The system of claim 1, wherein the first and the second data store are included in a data store cluster configured to load balance data requests based on a number of the data requests from the LVT system.

12. The system of claim 11, comprising a data extract server communicatively coupled to the data store cluster, wherein the data extract server is configured to extract, transform, and load (ETL) the loan data into the first data store from one or more external data stores storing the loan data, wherein the one or more external data stores are included in a system of record (SOR) configured as an authoritative data source for the loan data.

13. The system of claim 1, wherein the characteristic of the retrieved loan data comprise a tag denoting a type of loan data, a keyword representative of the type of loan data, or a combination thereof.

14. The system of claim 1, wherein the LVT system is further configured to generate a regulatory report based on the loan validation result.

15. The system of claim 14, wherein the regulatory report comprises a Federal Reserve Bank (FRB) Regulatory Report comprising a FR Y-14Q Schedule H.1, FR Y-14Q Schedule H.2, FR Y-9C, FR Y-14Q/M, FR Y-1, FR 2052a FFIEC 031, FFIEC 101, FFIEC 009, or a combination thereof.

16. The system of claim 14, wherein the LVT system is further configured to interface with a regulatory system to upload the regulatory report automatically into the regulatory system after the regulatory report is generated.

17. A non-transitory machine-readable medium storing instructions that, when executed by a computer system, cause the computer system to perform operations comprising:
retrieving a loan data stored in a first data store containing commercial and industrial (C&I) loan data, commercial real estate (CRE) loan data, off-balance sheet (OBS) loan data, commitment to issue a commitment (CTC) loan data, or a combination thereof;
retrieving, from a second data store, a set of configurable business rules;
selecting, via a loan validator tool (LVT) system executable via one or more processors, one or more configurable business rules from the set of configurable business rules based on a characteristic of the retrieved loan data;
applying, via the LVT system, the selected configurable business rules to the loan data to validate the loan data;
generating a loan validation result; and
updating one or more configurable business rules in the set of configurable business rules via the second data store with minimal or no interruptions to operations of the LVT.

18. The non-transitory machine-readable medium storing instructions of claim 17, wherein each of the configurable business rule in the set of configurable business rules includes executable code and wherein the executable code comprises a structured query language (SQL) code configured to use the loan data as input and to output a validation metric.

19. A method, comprising:
retrieving a loan data stored in a first data store containing commercial and industrial (C&I) loan data, commercial real estate (CRE) loan data, off-balance sheet (OBS) loan data, commitment to issue a commitment (CTC) loan data, or a combination thereof;
retrieving, from a second data store, a set of configurable business rules;
selecting, via a loan validator tool (LVT) system executable via one or more processors, one or more configurable business rules from the set of configurable business rules based on a characteristic of the retrieved loan data;
applying, via the LVT system, the selected configurable business rules to the loan data to validate the loan data;
generating a loan validation result; and
updating one or more configurable business rules in the set of configurable business rules via the second data store with minimal or no interruptions to operations of the LVT.

20. The method of claim 19, wherein each of the configurable business rule in the set of configurable business rules includes executable code and wherein the executable code comprises a structured query language (SQL) code configured to use the loan data as input and to output a validation metric.
